(19) United States
(12) Patent Application Publication
(10) Pub. No.: US 2017/0250759 A1
(43) Pub. Date: Aug. 31, 2017

(54) OPTICAL TRANSMITTER, OPTICAL TRANSMISSION DEVICE, AND TRANSMISSION METHOD

(71) Applicant: FUJITSU LIMITED, Kawasaki-shi (JP)

(72) Inventors: Shuhei HATAE, Kawasaki (JP); Masato OOTA, Atsugi (JP); Akiko FURUYA, Yokohama (JP); Tomoki KATOU, Kawasaki (JP)

(73) Assignee: FUJITSU LIMITED, Kawasaki-shi (JP)

(21) Appl. No.: 15/435,876

(22) Filed: Feb. 17, 2017

(30) Foreign Application Priority Data
Feb. 29, 2016 (JP) 2016-037400

(51) Int. Cl. H04B 10/548

(52) U.S. Cl. CPC H04B 10/548

(57) ABSTRACT

An optical transmitter includes a signal-processing circuit configured to perform signal processing on a first transmission signal and output a second transmission signal; an optical modulator configured to modulate input light with the second transmission signal and to output an optical signal; and a control circuit configured to output a control signal for controlling a carrier frequency of the optical signal to the signal-processing circuit, wherein the signal-processing circuit includes a map-adjustment circuit configured to adjust, based on the control signal and a modulation format, a map position of the second transmission signal onto a complex plane, and a phase-rotation circuit configured to apply, on the complex plane, rotation of a phase of the carrier frequency corresponding to the control signal to the second transmission signal at the adjusted map position.

### CROSS-REFERENCE TO RELATED APPLICATION

This application is based upon and claims the benefit of priority of the prior Japanese Patent Application No. 2016-037400, filed on Feb. 29, 2016, the entire contents of which are incorporated herein by reference.

### FIELD

The embodiments discussed herein are related to an optical transmitter, and an optical transmission device that performs wavelength multiplexing by using a plurality of optical transmitters, and a transmission method.

### BACKGROUND

With an increase in data traffic, there are demands for higher transmission rates of optical communications networks, and high-speed communication at 40 gigabits per second (Gbps), 100 Gbps, and so on per wavelength is being put into practical use. As a technique for realizing high-speed optical communication, transmission-and-reception of an optical signal through digital signal processing has attracted attention.

In a transmitting end, a signal-processing circuit maps transmission data onto electric-field information and uses the mapped electric-field information to modulate optical waves from a transmission light source, and the transmitting end transmits the modulated optical waves. A plurality of optical transmitters generates an optical signal having different wavelengths or carrier frequencies and multiplexes the optical signal to thereby perform wavelength multiplexing. When the oscillation frequency of the transmission light source is displaced from a desired value owing to a temperature change or aging deterioration, this displacement affects the quality of transmission, thus impeding an increase in the density of wavelength multiplexing.

Accordingly, a method in which a signal-processing circuit pre-corrects displacement of a carrier frequency has been proposed (for example, see Japanese Laid-open Patent Publication No. 2012-120010). Phase rotation in an opposite direction is applied to the electric field phase of mapped electric-field information in accordance with the displacement of the carrier frequency to thereby control the carrier frequency.

A method in which two types of constellation map are prepared and are switched at each transmission timing of bit data is available in order to reduce a peak-to-average power ratio (PAPR) of a multi-value optical signal (for example, see Japanese Laid-open Patent Publication No. 2014-007642). In this method, symbol positions on two types of map are amplitude-limited so as not to exceed the maximum amplitude of outputs of an analog-to-digital converter (ADC).

When phase rotation corresponding to displacement of a carrier frequency is pre-applied to mapped data, high-density wavelength multiplexing is realized, and the efficiency of using a frequency band improves. However, when a signal point exceeds the upper limit of a dynamic range as a result of the phase rotation processing, rounding into the dynamic range occurs. In this case, constellation distortion occurs, the accuracy of detecting symbol positions decreases, and a bit error rate (BER) deteriorates to reduce the transmission distance, thereby reducing the communication performance.

### SUMMARY

According to an aspect of the invention, an optical transmitter includes a signal-processing circuit configured to perform signal processing on a first transmission signal and output a second transmission signal; an optical modulator configured to modulate input light with the second transmission signal and to output an optical signal; and a control circuit configured to output a control signal for controlling a carrier frequency of the optical signal to the signal-processing circuit, wherein the signal-processing circuit includes a map-adjustment circuit configured to adjust, based on the control signal and a modulation format, a map position of the second transmission signal onto a complex plane, and a phase-rotation circuit configured to apply, on the complex plane, rotation of a phase of the carrier frequency corresponding to the control signal to the second transmission signal at the adjusted map position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates frequency-displacement correction using phase rotation;

FIG. 2 illustrates a problem that arises with the scheme illustrated in FIG. 1;

FIG. 3 illustrates a problem that arises when amplitude limitation of symbol points is applied to carrier-frequency control using phase rotation;

FIG. 4 illustrates mapping adjustment in a first embodiment;

FIG. 5 illustrates a procedure of the mapping adjustment in the first embodiment;

FIGS. 6A and 6B are diagrams illustrating the procedure of the mapping adjustment in the first embodiment;

FIG. 7 is a flowchart illustrating a method for the mapping adjustment in the first embodiment;

FIGS. 8A and 8B illustrate a mapping pattern after adjustment when the number of symbol points is 32;

FIGS. 9A and 9B illustrate a mapping pattern after adjustment when the number of symbol points is 64;

FIG. 10 illustrates mapping adjustment in a second embodiment;

FIGS. 11A to 11C are diagrams illustrating a procedure of the mapping adjustment in the second embodiment;

FIG. 12 illustrates the procedure of the mapping adjustment in the second embodiment;

FIG. 13 is a flowchart of a mapping adjustment method in the second embodiment;

FIGS. 14A and 14B are diagrams illustrating mapping adjustment when the number of symbol points is 32;

FIGS. 15A and 15B are diagrams illustrating mapping adjustment when the number of symbol points is 64;

FIG. 16 is a schematic diagram of an optical transmitter and an optical transmission system in the embodiments;

FIG. 17 illustrates correction of displacement of a carrier frequency;

FIG. 18 is a flowchart of an operation of a signal-processing circuit in an optical transmitter;

FIGS. 19A to 19C are diagrams illustrating advantages of the embodiments; and

FIG. 20 is a schematic diagram of an optical transmission device that realizes wavelength multiplexing by using a plurality of optical transmitters.

### DESCRIPTION OF EMBODIMENTS

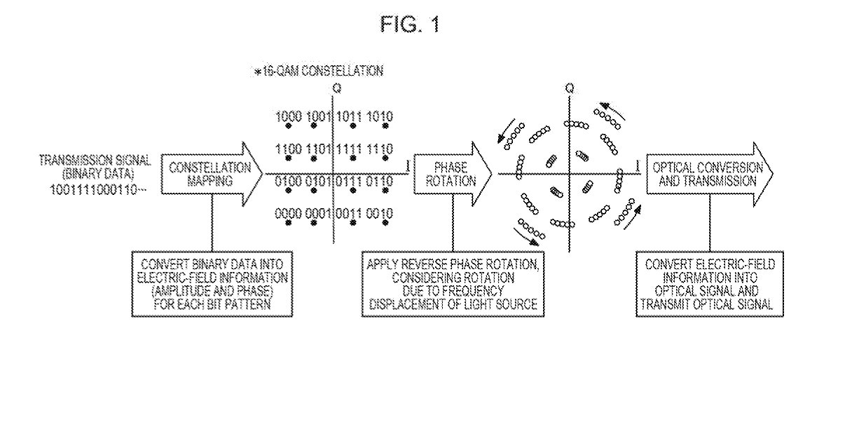

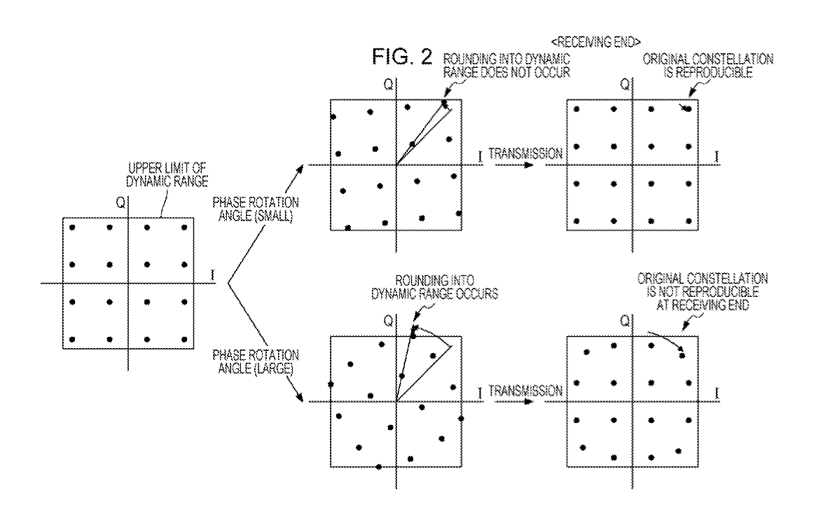

FIGS. 1 and 2 illustrate a problem that arises with a scheme for applying phase rotation corresponding to a frequency displacement of carrier waves.

A signal-processing circuit in an optical transmitter maps externally input transmission signal onto electric-field information in accordance with a modulation format, such as Quadrature Phase-Shift Keying (QPSK), Quadrature Amplitude Modulation (QAM), or Orthogonal Frequency Division Multiplexing (OFDM). For example, when modulation using a 16-QAM system is performed input data is divided into bit strings each having four bits, and the bit strings are mapped on signal points (symbol points) on a complex plane (IQ plane). This is referred to as “constellation mapping”. Each symbol point on the constellation corresponds to electric-field information determined by an amplitude and a phase.

Owing to variations in the oscillation frequency of a transmission light source and influences of a transmission path, the constellation appears to be rotated at a receiving end. Accordingly, a transmitting end pre-rotates the phase in an opposite direction to perform correction.

In the example illustrated in FIG. 1, the phase is rotated in the counterclockwise direction at a certain cycle. Carrier waves output from the light source are modulated with electric-field information obtained by applying phase rotation, and resulting signals are transmitted as an optical signal.

As denoted by upper lines in FIG. 2, when the angle of phase rotation applied after mapping is small, the symbol points after the phase rotation lie in a dynamic range, thus allowing the receiving end to reproduce the original constellation.

In contrast, as denoted by lower lines in FIG. 2, when the angle of phase rotation is large, and the symbol points exceed the upper limit of the dynamic range, rounding into the dynamic range occurs. As a result, the constellation is distorted, thus causing a problem that it is difficult for the receiving end to reproduce the original constellation. Owing to the distortion of the constellation, the amount of noise increases, the amount of bit error increases, and the transmission characteristics deteriorate.

Reducing the amplitude so that a trace P of the outermost points during the phase rotation fit in the area of the dynamic range is conceivable in order to ensure that the constellation distortion due to the phase rotation does not occur. However, another problem arises.

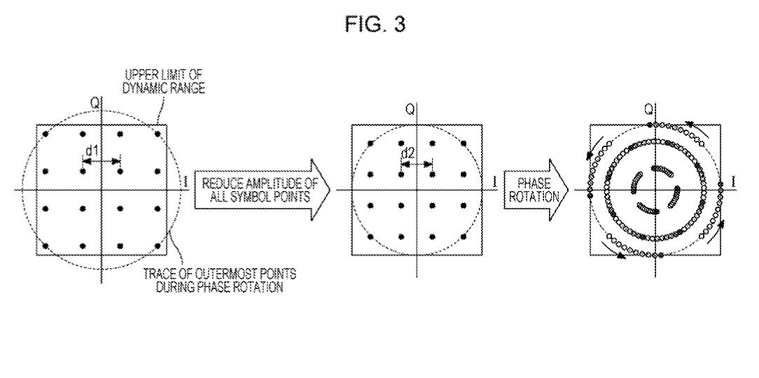

FIG. 3 illustrates problems when amplitude control of symbol points is applied to carrier-frequency control using phase rotation. In the state at the left side in FIG. 3, the distance between the closest symbols is d1, which is large, but upon the phase rotation, some symbol points exceed the upper limit of the dynamic range, and rounding into the dynamic range occurs.

As illustrated in the diagram at the middle, when the amplitude is reduced, a distance d2 between the closest symbols becomes smaller than the inter-symbol distance d1 before the amplitude limitation is performed, and as illustrated in the right diagram, even when the phase rotation is applied, constellation distortion due to rounding does not occur. Under a favorable signal-to-noise ratio (S/N ratio) condition, problems of a decrease in the symbol position detection accuracy and a decline in a BER can be solved.

However, under an unfavorable S/N ratio condition, the problems that the BER deteriorates and the transmission distance is not extensible owing to the reduced inter-symbol distance arise. Accordingly, in embodiments, when the carrier-frequency control using phase rotation is performed, mapping adjustment with which the inter-symbol distance is the largest in the area of the dynamic range is performed. This improves the quality of transmission, while maintaining the efficiency of using a frequency band.

### First Embodiment

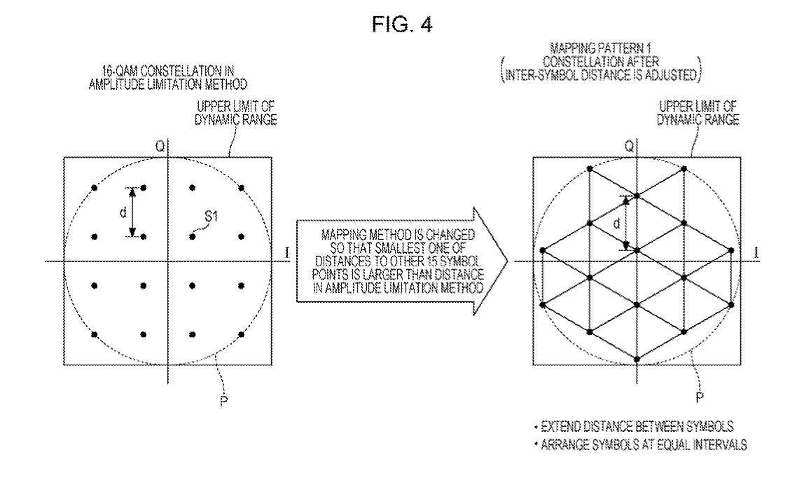

FIG. 4 is a diagram illustrating mapping adjustment in a first embodiment. In the first embodiment, a hexagonal close-packed arrangement is used to adjust the symbol positions. Mapping adjustment (symbol position adjustment) in the first embodiment will now be described in conjunction with an example of 16-QAM. The left diagram in FIG. 4 illustrates a state in which the amplitude of symbol points is limited so that a trace P of the outermost points during the phase rotation does not exceed the upper limit of the dynamic range. This scheme is referred to as an “amplitude limitation method”, for the sake of convenience. As a result of the amplitude limitation, the distance d between the symbols decreases, compared with original mapping positions in 16-QAM.

Since the trace P of the outermost points during the phase rotation fits in the inscribed circle of the upper limit of the dynamic range, rounding into the dynamic range does not occur, but the quality of transmission deteriorates under an unfavorable S/N ratio condition. In order to address this problem, in the first embodiment, mapping is adjusted so that the smallest one of the distances from one symbol point S1 to the other 15 symbol points is larger than the inter-symbol distance in the amplitude limitation method.

The right diagram in FIG. 4 illustrates a state after the mapping adjustment. This state is referred to as “mapping pattern 1”. In mapping pattern 1, mapping is adjusted so that the inter-symbol distance is the largest and the symbols are arranged at equal intervals in a range in which the amplitude does not exceed the inscribed circle of the upper limit of the dynamic range.

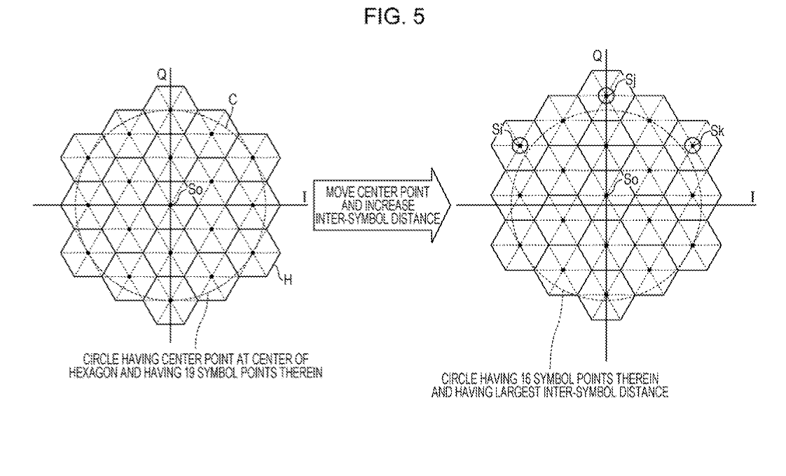

With mapping pattern 1, even when phase rotation for controlling the carrier frequency is applied, distortion of the constellation is inhibited in a state in which the inter-symbol distance is maintained as large as possible. This makes it possible to improve both the efficiency of using the frequency band and the quality of transmission. FIG. 5 is a diagram illustrating the mapping adjustment method in FIG. 4. In this mapping adjustment, hexagons H having symbol points at the respective centers thereof are arranged without gaps, and an inscribed circle C of the upper limit of the dynamic range is determined using one symbol point as the center thereof. Mapping adjustment when the number of symbol points is 16 is performed according to the following procedure.

(1) Hexagons H having symbol points at the respective centers thereof are arranged without gaps, and a smallest circle C having at least 16 symbol points therein is determined in the range of the upper limit of the dynamic range. As illustrated in the left diagram in FIG. 5, the smallest circle C that contains at least 16 symbol points has 19 symbol points therein.

(2) The symbol positions are adjusted so that 16 symbol points fit in the circle C and the inter-symbol distance is the largest. More specifically, a symbol point So at the center of the circle C is moved to cause three symbol points Si, Sj, and Sk of six symbol points (these are referred to as “outermost points”) that are the farthest from the center of the circle C to lie outside the circle C. In addition, the intervals of all the symbols are increased so that the symbol points at the outermost points inside the circle C lie on the circumference of the circle C or are in the circumference of the circle C and the closest thereto. This makes it possible to maximize the distance between the symbols, while maintaining the inter-symbol distances at equal intervals.

(3) After the mapping adjustment, mapping pattern 1 in which the 16 symbols are arranged at equal intervals and the inter-symbol distances are the largest is generated, as illustrated in FIG. 5. With mapping pattern 1, when the phase rotation is applied in order to correct the displacement of the carrier frequency, it is possible to inhibit constellation distortion and it is possible to maintain the quality of transmission.

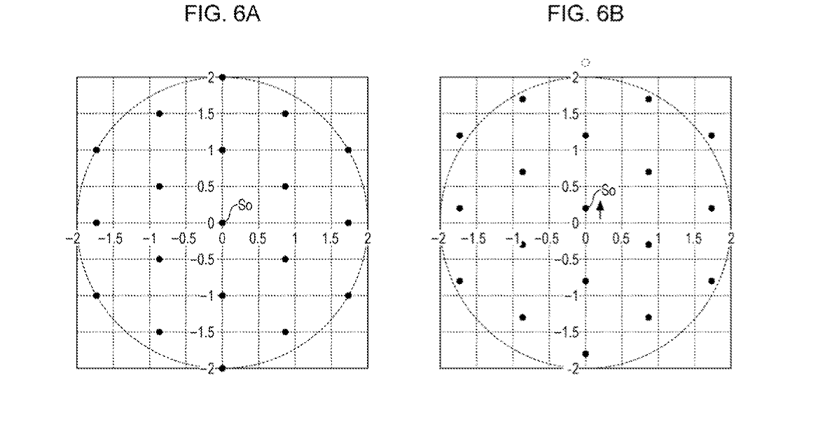

FIG. 6A illustrates movement of the symbol point So in the inscribed circle of the dynamic range upper limit.

In FIG. 6B, the symbol point So is moved along a Q axis in a plus direction in order to cause three symbol points to lie outside the inscribed circle, but the present disclosure is not limited to this example. As long as the inter-symbol distances can be generally increased by causing a number of symbol points which corresponds to a difference from a predefined number of symbols to lie outside the inscribed circle, the symbol point So may be moved in a minus direction in parallel with the Q axis or may be moved in a plus or minus direction in parallel with an I axis.

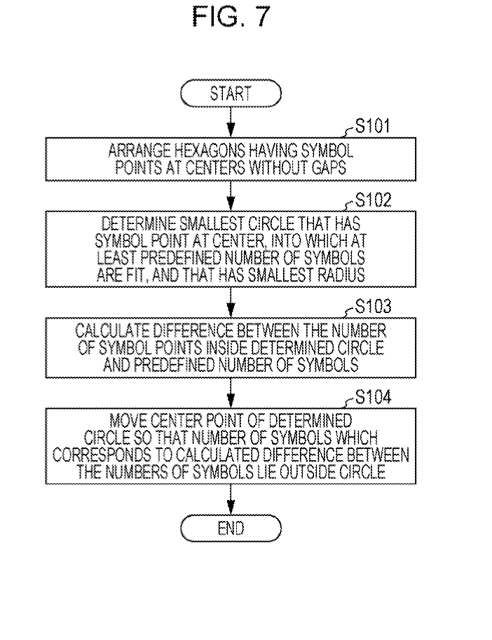

FIG. 7 is a flowchart illustrating the mapping adjustment method in the first embodiment. First, hexagons having symbol points at the respective centers thereof are arranged on an IQ plane without gaps (S101). The size of the hexagons is appropriately set depending on the upper limit of the dynamic range and a modulation format (or a multi-value number). Next, a smallest circle that has one symbol point at the center point thereof and into which at least a number of symbols which corresponds to the modulation format fit is determined (S102).

The difference between the number of symbol points inside the determined circle and a predefined number of symbols is calculated (S103).

In the case of 16-QAM, a smallest circle that contains at least 16 symbol points includes 19 symbol points, and the difference is three symbols. In the case of 32-QAM, a smallest circle that contains at least 32 symbol points includes 37 symbol points, and the difference is five symbols. The center point of the circle is moved so that a number of symbol points which corresponds to the difference lie outside the circle, and the distances between the symbols are generally extended so that the outermost points inside the circle lie on the circumference or are the closest to the circumference (S104).

When a frequency displacement of a carrier wave occurs during operation, an optical transmitter may execute the flow of this mapping adjustment in real time in accordance with a modulation format. Alternatively, mapping pattern 1 may be generated for each modulation format in advance, and a predefined constellation and mapping pattern 1 may be selectively used depending on whether or not there is a frequency displacement of the carrier wave.

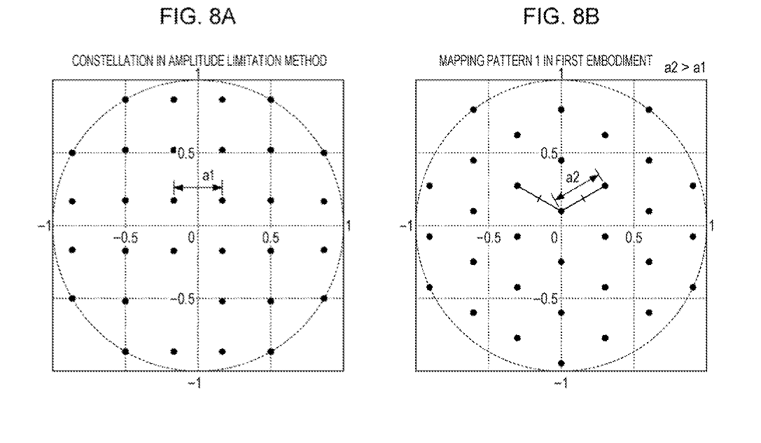

FIGS. 8A and 8B illustrate mapping pattern 1 after the adjustment when the number of symbols is 32, in comparison with a constellation in the amplitude limitation method. In the simple amplitude limitation method in FIG. 8A, the amplitude is reduced so that the 32 symbol points fit in the inscribed circle of the upper limit of the dynamic range.

In FIG. 8A, the distance between the closest symbols is a1. In mapping pattern 1 illustrated in FIG. 8B, the distances between the symbols are generally extended so that an excessive number of symbol points are caused to lie outside the circle, based on a hexagonal close-packed arrangement, and so that the symbol positions of the outermost points inside the circle lie on the circumference or are the closest to the circumference. In mapping pattern 1, the symbol points are arranged at equal intervals, and the distance between the symbols is a2. The inter-symbol distance a2 in mapping pattern 1 is larger than the smallest inter-symbol distance a1 in the amplitude limitation method (a2>a1).

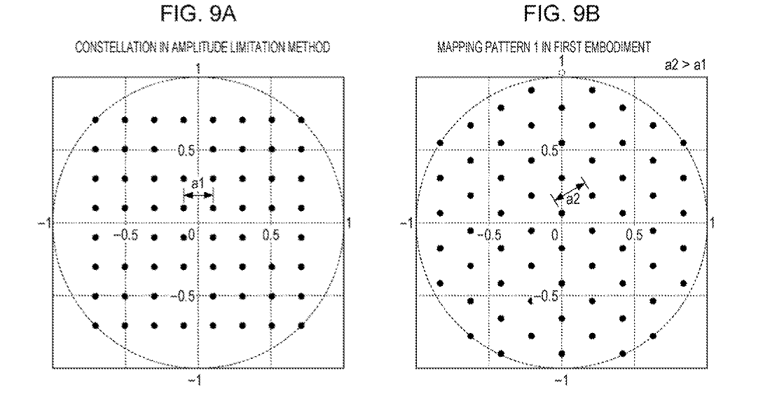

FIGS. 9A and 9B illustrate mapping pattern 1 after the adjustment when the number of symbols is 64, in comparison with a constellation in the amplitude limitation method. In the simple amplitude limitation method in FIG. 9A, the amplitude is reduced so that the 64 symbol points fit in the inscribed circle of the upper limit of the dynamic range. The distance between the closest symbols is a1.

In mapping pattern 1 illustrated in FIG. 9B, the distances between the symbols are generally extended so that a number of symbol points which exceeds 64 points are caused to lie outside the circle, based on a hexagonal close-packed arrangement, and so that the symbol positions of the outermost points inside the circle lie on the circumference or are the closest to the circumference.

In mapping pattern 1, the symbol points are arranged at equal intervals, and the distance between the symbols is a2. The inter-symbol distance a2 in mapping pattern 1 is larger than the smallest inter-symbol distance a1 in the amplitude limitation method (a2>a1).

Comparison of FIGS. 8A and 8B with FIGS. 9A and 9B indicates that the advantages of the first embodiment are greater as the multi-value number for modulation increases. For higher transmission rates, an increase in the multi-value number for modulation and an increase in the number of wavelengths to be multiplexed are expected in coming years, and a demand for controlling a carrier frequency is thought to be increasingly becoming severe. In such a case, performing the mapping adjustment in the first embodiment makes it possible to inhibit constellation distortion and makes it possible to maintain the quality of transmission.

### Second Embodiment

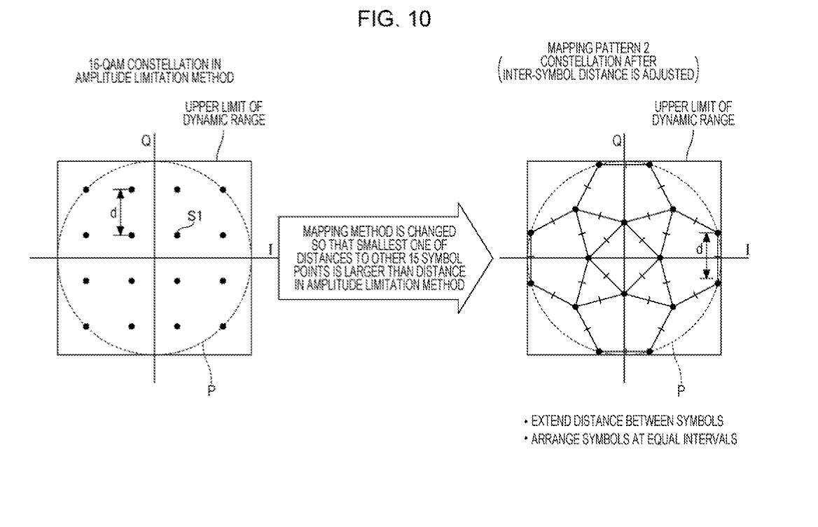

FIG. 10 illustrates mapping adjustment in a second embodiment. In the second embodiment, a plurality of circles (power bands) having the same center is formed, symbol points are arranged on the circumference at equal intervals sequentially from the inner circle (that is, the circle having a smaller radius), and the symbol positions are adjusted. Mapping adjustment (symbol position adjustment) will now be described in conjunction with an example of 16-QAM. The left diagram in FIG. 10 illustrates a state in which the amplitude of the symbol points is adjusted using the amplitude limitation method so that a trace P of the outermost points during phase rotation does not exceed the upper limit of the dynamic range. In this state, the distance d between the symbols is reduced, compared with the original mapping positions in 16-QAM. Since the trace P of the outermost points during phase rotation fits in the inscribed circle of the upper limit of the dynamic range, rounding into the dynamic range does not occur. However, under an unfavorable S/N ratio condition (a portion where the inter-symbol distance is small), the quality of transmission deteriorates.

In order to overcome this problem, in the second embodiment, mapping is adjusted so that the smallest one of the distances from one symbol point S1 to the other 15 symbol points is larger than the smallest inter-symbol distance d in the amplitude limitation method. The right diagram in FIG. 10 illustrates a state after the mapping adjustment is performed. This state is referred to as “mapping pattern 2”. In mapping pattern 2, symbol positions at which the inter-symbol distance is the largest and the symbols lie at equal intervals are selected sequentially from the center of the circle in a range in which the amplitude does not exceed the inscribed circle of the upper limit of the dynamic range. With mapping pattern 2, even when the carrier frequency is controlled to apply phase rotation, distortion of the constellation is inhibited in a state in which the inter-symbol distance is maintained as large as possible. This makes it possible to improve both the efficiency of using the frequency band and the quality of transmission.

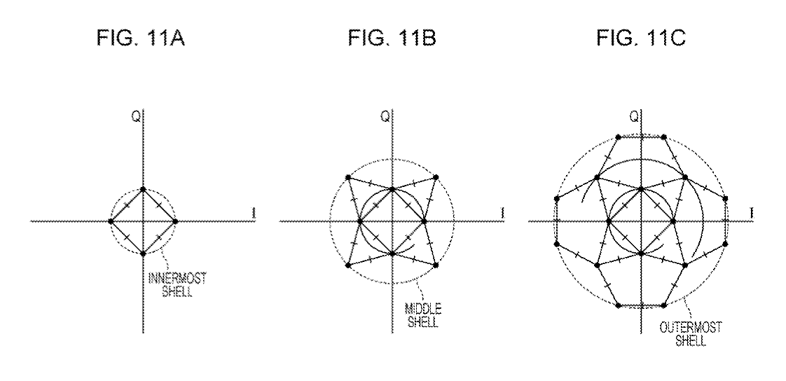

FIGS. 11A to 11C are diagrams illustrating the mapping adjustment method illustrated in FIG. 10. When the number of symbol points is 16, three circles having the same center point are determined. The three circles are herein referred to as an “innermost shell”, a “middle shell”, and an “outermost shell” in order of increasing radii. Since each circle represents the amplitude of an electric field, these concentric circles are referred to as “power bands”.

Four symbol points are arranged on the circumference of the innermost shell. Four symbol points are arranged on the circumference of the middle shell. Eight symbol points are arranged on the circumference of the outermost shell. The outermost shell may match the inscribed circle of the upper limit of the dynamic range. The number of power bands (concentric circles), the radii of the power bands, and the number of symbols on each circle are determined using a method (described below) in accordance with the upper limit of the dynamic range and a modulation format.

In FIG. 11A, the symbol points on the innermost shell are arranged at positions obtained by equally dividing the circumference by the number of symbol points (four points in this example). As a result of this processing, the inter-symbol distance d, which is a reference for mapping, is uniquely determined. Although four symbol points are provided on an I axis and a Q axis in FIG. 11A, the present disclosure is not limited to this example, and the four symbols may be arranged at any positions on the circumference as long as they are arranged at equal intervals.

In FIG. 11B, the symbol points on the middle shell are arranged at positions where the distance from two adjacent symbol points on the innermost shell is d. As a result, four regular triangles that extend radially are formed, each triangle being defined by two adjacent symbol points on the innermost shell and one symbol point on the middle shell. In FIG. 11C, each symbol points on the outermost shell is arranged at a position where the distance from the closest symbol point on the middle shell is d, the distance from the other adjacent symbol point on the outermost shell is larger than or equal to d, and the radius of the outermost shell is minimized.

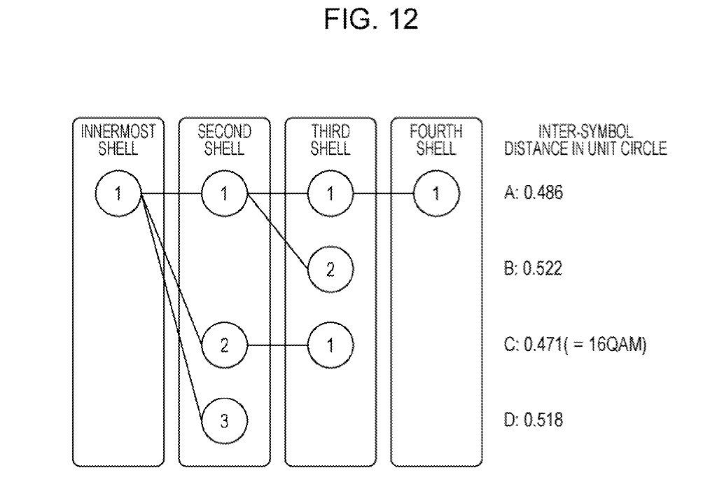

When mapping is performed regarding this outermost shell as the inscribed circle of the upper limit of the dynamic range, the symbols can be arranged at equal intervals, and the inter-symbol distance can be maximized. FIG. 12 is a diagram illustrating a method for determining the number of power bands and the number of symbol points to be arranged on each circumference.

A description will be given while paying attention to one of four quadrants in an orthogonal coordinate system on an IQ plane. The state of the entire IQ plane can be determined by quadrupling the state in FIG. 12. When the number of symbols is 16, four symbol points are arranged in one quadrant.

First, one symbol is arranged in each quadrant in the innermost shell (indicated by “1” in the field “innermost shell” in FIG. 12).

Next, a combination of symbol points that can be arranged on the second shell, which has the second smallest radius, is determined. Since one symbol has been arranged in the innermost shell, the remaining number of symbols is three. As the arrangement of the second shell, there are three patterns, that is, a pattern in which one symbol is arranged (“1” is indicated in the field “second shell”), a pattern in which two symbols are arranged (“2” is indicated in the field “second shell”), and a pattern in which three symbols are arranged (“3” is indicated in the field “second shell”).

Next, a combination of symbol points that can be arranged on the third shell, which has the third smallest radius, is determined. When the number of symbols on the second shell is “1”, the remaining number of symbols is two. In this case, there are combination A in which one symbol is arranged on each of the third shell and the outermost shell and combination B in which two symbols are arranged on the third shell.

When the number of symbols on the second shell is “2”, the remaining number of symbol is one, and thus this symbol is arranged on the third shell. As a result, combination C in which “1”, “2”, and “1” are arranged sequentially from the innermost shell is determined. When the number of symbols on the second shell is “3”, a symbol to be arranged does not remain, and thus combination D in which one symbol is arranged on the innermost shell and three symbol points are arranged on the second shell is obtained for each quadrant. A combination in which the amplitude (radius) of the outermost shell fits in the inscribed circle of the upper limit of the dynamic range and the inter-symbol distance is the largest is selected from combinations A to D. When symbols are arranged in a unit circle having a radius normalized to 1 in accordance with the procedure in FIG. 10, the inter-symbol distance in combination A is 0.486, and the inter-symbol distance in combination B is 0.522. The inter-symbol distance in combination C is 0.471.

This value is the same as the smallest inter-symbol distance in the original mapping in 16-QAM, and the S/N ratio deteriorates. The inter-symbol distance in combination D is 0.518. As a result, combination B with which the inter-symbol distance is the largest is selected. When one quadrant is considered, the numbers of symbol points are 1, 1, and 2 sequentially from the innermost shell, and thus, when four quadrants are considered, the numbers of symbol points to be arranged are 4, 4, and 8.

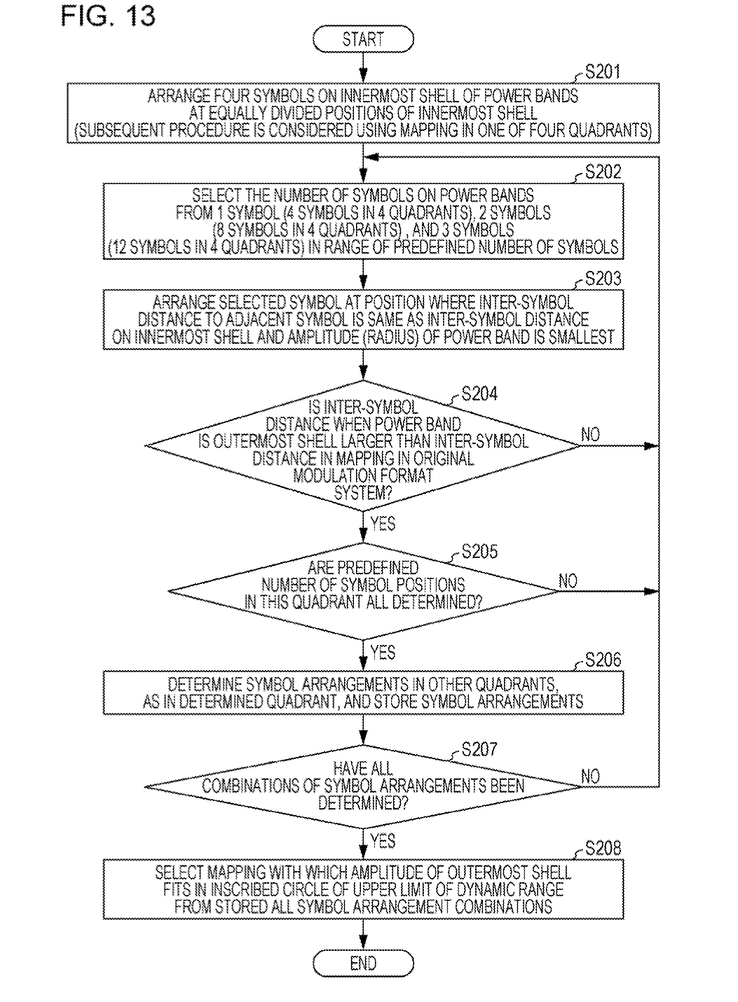

FIG. 13 is a flowchart of the mapping adjustment method in the second embodiment. First, four symbols are arranged on the innermost shell of power bands on an IQ plane at equal intervals (S201). The following processing is performed on one of four quadrants in an orthogonal coordinate system on the IQ plane. The number of symbols to be arranged on the power bands other than the innermost shell is selected in the range of a predefined number of symbols, n, per quadrant (S202). The predefined number of symbols, n, per quadrant is one-fourth of the number of signal points determined by a modulation format. In the case of 16-QAM, the predefined number of signal points is four; in the case of 32-QAM, the predefined number of signal points is eight; and in the case of 64QAM, the predefined number of signal points is 16.

For example, the number of symbols, i, to be arranged on the second power band is selected from i=1, . . . , n−1 (i is a natural number). The number of symbols, j, to be arranged on the third power band is selected from j=1, . . . , n−1−i (j is a natural number). The smallest value “1” may be first selected as the number of symbols to be arranged on the power band, and then, each time processing is repeated through determinations in steps S204, S205, and S207 described below, the number of symbols may be incremented by 1.

Next, each selected symbol is arranged at a position where the distance to the adjacent symbol is the same as the inter-symbol distance d on the innermost shell and the amplitude (radius) of the power band in interest is minimized (S203). A determination is made as to whether or not the inter-symbol distance when the power band in interest is the outermost shell is larger than the smallest inter-symbol distance in symbol mapping in the original modulation format (S204). If the inter-symbol distance after the adjustment is smaller than or equal to the smallest inter-symbol distance in symbol mapping in the original modulation format (NO in S204), the advantage that the quality of transmission is improved while maintaining the efficiency of using the frequency band is not sufficiently obtained.

For example, combination C in FIG. 12 corresponds to this arrangement pattern. In this case, this symbol arrangement is excluded, and S202 and S203 are repeated. If the inter-symbol distance is larger than the smallest inter-symbol distance in symbol mapping in the original modulation format (YES in S204), a determination is made as to whether or not a predefined number of symbol positions in this quadrant are all determined (S205), and S202 to S204 are repeated until all positions of the predefined number of symbols are determined. If the predefined number of symbol positions in this quadrant are determined (YES in S205), the same symbol arrangement is determined for the remaining three quadrants, and all symbol arrangements are stored (S206). At this stage, one combination (a mapping pattern) is determined.

A determination is made as to whether or not all combinations of symbol arrangements have been determined (S207). If another combination of symbol arrangements remains (NO in S207), S202 to S206 are repeated, and another combination of symbol arrangements is determined. If all combinations of symbol arrangements have been determined (YES in S207), mapping with which the amplitude (radius) of the outermost shell fits in the inscribed circle of the upper limit of the dynamic range is selected from the stored all symbol arrangement combinations (S208), and then the processing ends.

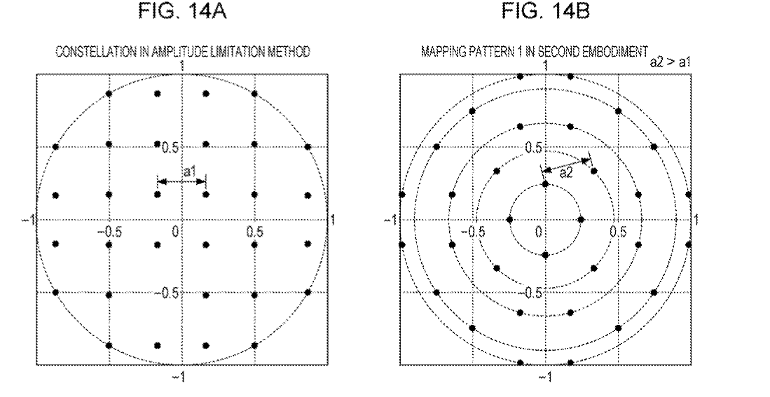

In the example illustrated in FIG. 12, combinations A, B, and D are selected. Although any of the mapping patterns may be used, combination B in which the inter-symbol distance in a unit circle is the largest is used. FIGS. 14A and 14B illustrate mapping pattern 2 after the adjustment when the number of symbols is 32, in comparison with a constellation in the amplitude limitation method. In the simple amplitude limitation method in FIG. 14A, the amplitude is reduced so that the 32 symbol points fit in the inscribed circle of the upper limit of the dynamic range.

In FIG. 14A, the distance between the closest symbols is a1. In mapping pattern 2 illustrated in FIG. 14B, symbols of four points, four points, eight points, eight points, and eight points are arranged on five circles (power bands) having the same center sequentially from inside.

These symbols are arranged at equal intervals, and a combination of symbol arrangements in which the inter-symbol distance is the largest is selected. In mapping pattern 2, the distance between the symbols is a2. The inter-symbol distance a2 in mapping pattern 2 is larger than the smallest inter-symbol distance a1 in the amplitude limitation method (a2>a1).

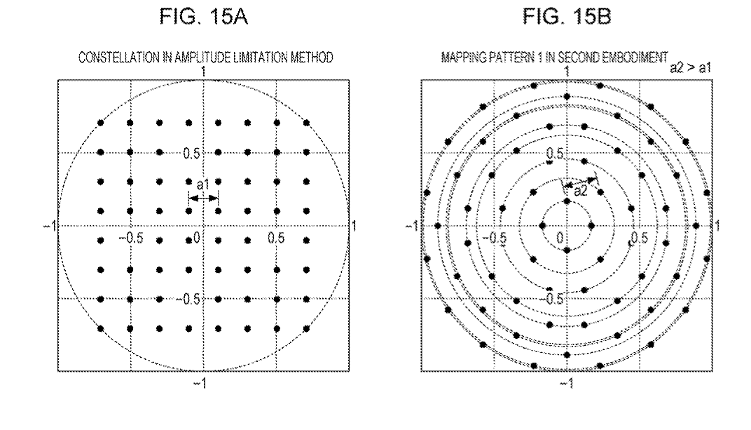

FIGS. 15A and 15B illustrate mapping pattern 2 after the adjustment when the number of symbols is 64, in comparison with a constellation in the amplitude limitation method. In the simple amplitude limitation method in FIG. 15A, the amplitude is reduced so that the 64 symbol points fit in the inscribed circle of the upper limit of the dynamic range.

The distance between the closest symbols is a1. In mapping pattern 2 illustrated in FIG. 15B, symbols of, four points, four points, eight points, eight points, eight points, four points, eight points, four points, eight points, and eight points are arranged on ten circles (power bands) having the same center sequentially from inside. These symbols are arranged at equal intervals, and a symbol arrangement in which the inter-symbol distance is the largest, that is, a combination in which the outermost shell fits in the inscribed circle of the dynamic range upper limit, is selected.

In mapping pattern 2, the distance between the symbols is a2. The inter-symbol distance a2 in mapping pattern 2 is larger than the smallest inter-symbol distance a1 in the amplitude limitation method (a2>a1). Comparison of FIGS. 14A and 14B with FIG. 15A and FIG. 15B indicates that the advantages of the second embodiment are greater as the multi-value number for modulation increases. For higher transmission rates, an increase in the multi-value number for modulation and an increase in the number of wavelengths to be multiplexed are expected in coming years, and a demand for controlling a carrier frequency is thought to be increasingly becoming severe. Even in this case, performing the mapping adjustment in the second embodiment makes it possible to inhibit constellation distortion and makes it possible to maintain the quality of transmission.

<Device Configuration>

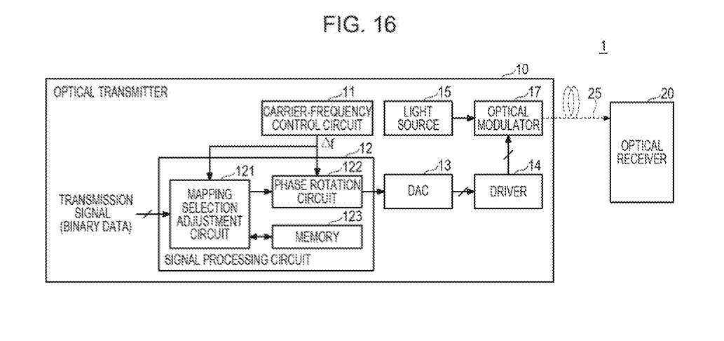

FIG. 16 is a schematic block diagram of an optical transmitter 10 in the embodiments. The optical transmitter 10 is connected to an optical receiver 20 through an optical transmission path 25 to transmit an optical signal. The optical transmitter 10 includes a carrier-frequency control circuit 11, a signal-processing circuit 12, a digital-to-analog converter (DAC) 13, a driver 14, a light source 15, and an optical modulator 17. The light source 15 is, for example, a laser light source that oscillates output light at a predetermined frequency f. The signal-processing circuit 12 is, for example, a digital signal processor (DSP) and performs digital signal processing on transmission signal, which are binary data that are externally input. The signal-processing circuit 12 has a mapping selection adjustment circuit 121, a phase rotation circuit 122, and a memory 123.

Operations of the individual circuits are described later. The DAC 13 converts digital signals output from the signal-processing circuit 12 into analog signals. The driver 14 amplifies the signals from the DAC 13 to generate drive signals and drives the optical modulator 17 by using the drive signals. The optical modulator 17 modulates the output light from the light source 15 by using the drive signals that carry transmission information and outputs the modulated light to the optical transmission path 25 as an optical signal. The carrier-frequency control circuit 11 outputs control signals for controlling the carrier frequency of the optical signal output from the optical modulator 17.

The control signals include a frequency control amount Δf representing displacement of the carrier frequency from a design value. The frequency control amount Δf may be detected by monitoring part of the light output from the optical modulator 17 and observing displacement of the center frequency. Alternatively, the frequency control amount Δf may be determined based on a quality detection result of the BER, the S/N ratio, or the like obtained at the receiver end. The frequency control amount Δf is supplied to both the mapping selection adjustment circuit 121 and the phase rotation circuit 122 in the signal-processing circuit 12.

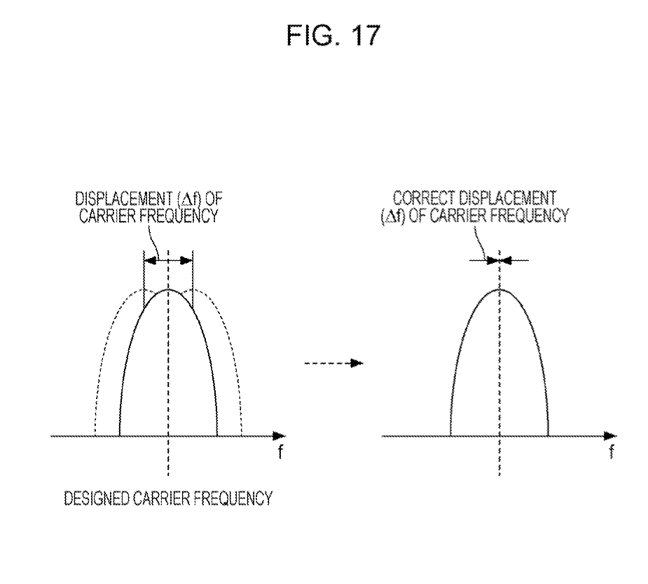

FIG. 17 is a diagram illustrating displacement of a carrier frequency. The oscillation frequency of the light source 15 varies owing to a temperature change and aging deterioration and is displaced from a designed carrier frequency (a center frequency). This amount of displacement is represented by Δf. The frequency displacement of the carrier wave has a large influence on high-density wavelength multiplexing. Accordingly, the displacement of the carrier frequency is compensated for at the stage of signal processing performed at the transmitting end.

Referring back to FIG. 16, the mapping selection adjustment circuit 121 selects or adjusts a mapping pattern in accordance with the value of input Δf. When the frequency control amount Δf is zero (Δf=0), the mapping selection adjustment circuit 121 maps input transmission signal (binary data) onto a constellation by using the original modulation format corresponding to the original mapping system. Electric-field information E of mapped symbol points is given by E=A(t)·e^{jθ(t)}, where A (t) indicates an electric field strength at time t, and θ(t) indicates an electric field phase. When the frequency control amount Δf is not zero (Δf≠0), the mapping selection adjustment circuit 121 uses mapping pattern 1 in the first embodiment or mapping pattern 2 in the second embodiment.

In mapping pattern 1 or 2, all symbol points are arranged in the inscribed circle of the dynamic range upper limit, with the inter-symbol distance being maintained to be the largest. Thus, even when the phase rotation circuit 122 applies phase rotation, it is possible to inhibit rounding into the dynamic range and it is possible to maintain the quality of transmission. Mapping pattern 1 or 2 may be pre-stored in the memory 123 in association with each modulation format, or mapping adjustment (symbol position adjustment) may be performed in real time by using a computational operation function of the signal-processing circuit 12.

The phase rotation circuit 122 applies phase rotation, given by θ=2πΔft, to the electric field phase of the symbol points. When Δf is zero, the phase rotation is not applied, and electric-field information of signal points determined by the original constellation mapping is output to the DAC 13. When Δf is not zero, the phase rotation circuit 122 applies, at a certain cycle, phase rotation to the electric-field information of symbol points arranged using mapping pattern 1 or 2.

This pre-compensates for displacement of the carrier frequency and phase rotation that occurs on a transmission path. Even when any of mapping patterns 1 and 2 is used, the S/N ratio can be improved, since the inter-symbol distances are the largest and are maintained to be an equal distance. Also, since all symbol points lie in the inscribed circle of the dynamic range upper limit, it is possible to inhibit a decrease in the detection accuracy of symbol points and deterioration of an error rate.

Although the configuration of the optical receiver 20 is not illustrated, a front-end circuit receives an optical signal and converts the optical signal into electrical signals, and an analog-to-digital conversion is performed to convert the electrical signals into digital signals. An error rate detected during error correction in digital signal processing may be transmitted to the optical transmitter 10 through the optical transmission path 25 and be used by the carrier-frequency control circuit 11.

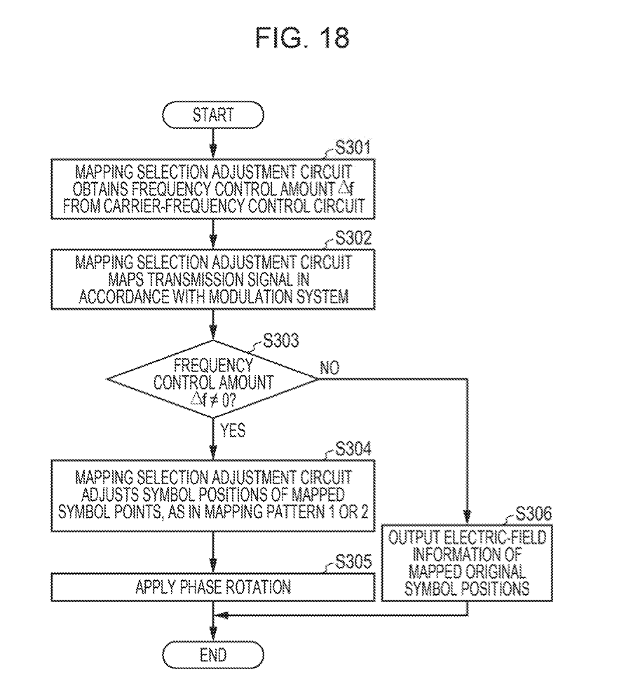

FIG. 18 is a flowchart illustrating an operation of the signal-processing circuit 12. First, the mapping selection adjustment circuit 121 and the phase rotation circuit 122 obtain the frequency control amount Δf from the carrier-frequency control circuit 11 (S301). The mapping selection adjustment circuit 121 maps input transmission signal onto an IQ plane in accordance with a modulation format (S302). The mapping selection adjustment circuit 121 and the phase rotation circuit 122 each determine whether or not the frequency control amount Δf has a value other than zero (S303).

If the frequency control amount Δf is zero (NO in S303), the mapping selection adjustment circuit 121 outputs, to the phase rotation circuit 122, electric-field information of symbol positions resulting from the original mapping. Upon receiving the electric-field information, the phase rotation circuit 122 directly outputs the electric-field information without applying phase rotation thereto (S306). If the frequency control amount Δf is not zero (YES in S303), the mapping selection adjustment circuit 121 adjusts the symbol positions (electric-field information) of the mapped symbol points, as illustrated in mapping pattern 1 or 2, and outputs values after the adjustment to the phase rotation circuit 122 (S304).

In order to compensate for Δf, the phase rotation circuit 122 applies phase rotation to the electric field phase at a certain cycle (S305). In the embodiment, mapping with which influences of the phase rotation are suppressed is used, and thus, even when displacement of the carrier frequency and influences of a transmission path are compensated for in advance, constellation distortion is inhibited while maintaining the inter-symbol distance. It is possible to improve the quality of transmission, while maintaining the efficiency of using a frequency band.

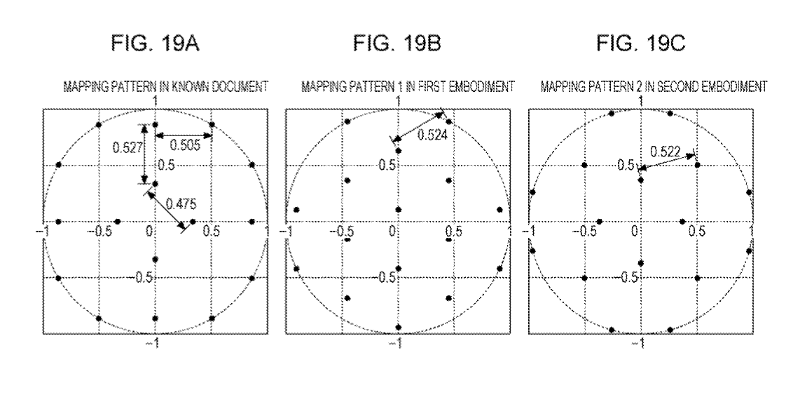

FIGS. 19A to 19C illustrate advantages of the embodiments. Mapping pattern 1 (FIG. 19B) in the first embodiment and mapping pattern 2 (FIG. 19C) in the second embodiment are illustrated in comparison with a mapping pattern (FIG. 19A) in the method in Japanese Laid-open Patent Publication No. 2014-007642. In all of the mapping patterns, symbol points are arranged on a unit circle having a radius of 1 in the example of 16-QAM.

According to the method in Japanese Laid-open Patent Publication No. 2014-007642, the inter-symbol distance on the outer circumference is 0.505, the inter-symbol distance on the inner circumference is 0.475, and the inter-symbol distance between the inner circumference and the outer circumference is 0.527. The smallest inter-symbol distance is 0.475.

In contrast, in the mapping methods in the first and second embodiments, the inter-symbol distances are set to an equal distance, and the inter-symbol distance is larger than the smallest inter-symbol distance in the related scheme. This configuration improves the S/N ratio and can increase the transmission distance.

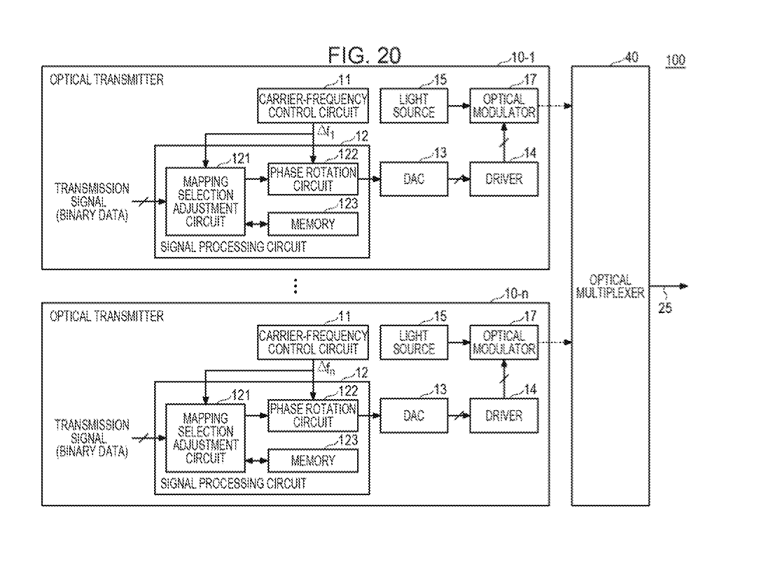

FIG. 20 is a schematic diagram of an optical transmission device 100 for wavelength multiplexing, the optical transmission device 100 using a plurality of optical transmitters 10 in the above-described embodiment. The optical transmission device 100 includes optical transmitters 10-1 to 10-n and an optical multiplexer 40. The individual optical transmitters 10 are each the same as or similar to the optical transmitter 10 in FIG. 16 and may be configured as respective discrete optical transmission chips.

Each optical transmitter 10 adjusts the mapping positions of transmission signal in accordance with the frequency control amount Δf and outputs an optical signal based on electric-field information obtained by applying phase rotation at the adjusted mapping positions.

The mapping selection adjustment circuit 121 in each optical transmitter 10 performs mapping adjustment that maximizes the inter-symbol distance, and thus, even when phase rotation is applied, it is possible to inhibit constellation distortion and it is possible to maintain the S/N ratio at a favorable value.

The optical signals output from the optical transmitters 10-1 to 10-n are multiplexed by the optical multiplexer 40. In this case, the carrier-frequency control circuits 11 in the individual optical transmitters 10 output different frequency control amounts Δf₁ to Δfₙ, so that wavelength multiplexing by which a plurality of optical signals having different center frequencies is multiplexed at a high density is realized using the same type of light source 15. The carrier-frequency control circuit 11 controls the frequency of each carrier wave, and the mapping selection adjustment circuit 121 adjusts the mapping positions so that constellation distortion does not occur.

Thus, in the case of wavelength multiplexing, it is possible to improve the quality of transmission, while maintaining the efficiency of using the frequency band through reduction of the frequency band occupied by each carrier wave. Although the preferred embodiments of the present disclosure have been described above, the present disclosure is not limited to the above-described embodiments, and various modifications are possible thereto. For example, the present disclosure is also applicable to optical orthogonal frequency division multiplexing (optical OFDM) by which a plurality of sub carriers is densely arranged in one optical signal band.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmitter comprising:
a signal-processing circuit configured to perform signal processing on a first transmission signal and output a second transmission signal;
an optical modulator configured to modulate input light with the second transmission signal and to output an optical signal; and
a control circuit configured to output a control signal for controlling a carrier frequency of the optical signal to the signal-processing circuit,
wherein the signal-processing circuit includes
a map-adjustment circuit configured to adjust, based on the control signal and a modulation format, a map position of the second transmission signal onto a complex plane, and
a phase-rotation circuit configured to apply, on the complex plane, rotation of a phase of the carrier frequency corresponding to the control signal to the second transmission signal at the adjusted map position.

2. The optical transmitter according to claim 1,
wherein, when the control signal indicates displacement of the carrier frequency, the map-adjustment circuit adjusts the map position of the second transmission signal, based on an arrangement pattern in which symbol points on an outermost shell that are determined according to the modulation format are in a range of an inscribed circle of a dynamic range upper limit of the optical transmitter and a distance between the symbols is largest.

3. The optical transmitter according to claim 2,
wherein the signal-processing circuit has a memory that stores the arrangement pattern therein; and
wherein, when the control signal indicates displacement of the carrier frequency, the map-adjustment circuit adjusts the map position of the second transmission signal by using the arrangement pattern stored in the memory.

4. The optical transmitter according to claim 2,
wherein the arrangement pattern is a pattern in which all inter-symbol distances are set to an equal distance through close-packed arrangement of hexagons on the complex plane.

5. The optical transmitter according to claim 4,
wherein the hexagons have symbol points at respective centers thereof; and the arrangement pattern is a pattern in which, in the close-packed arrangement of the hexagons, a smallest circle having a center point at one of the symbol points and including at least a number of symbol points which is determined by the modulation format is set to a symbol arrangement area, and a position of the center point is adjusted so that a number of symbol points which corresponds to a difference between the number of symbol points included in the smallest circle and a number of symbol points which is determined by the modulation format lie outside the smallest circle.

6. The optical transmitter according to claim 2,
wherein, in the arrangement pattern, symbol points are arranged on a plurality of circles having a same center on the complex plane, and each symbol point is arranged at an equal distance from a closest symbol point that lies on the inner or outer circle and that is adjacent to the symbol point.

7. The optical transmitter according to claim 6,
wherein the arrangement pattern is determined with reference to a distance between the adjacent symbols when the innermost circle is equally divided by four symbol points.

8. The optical transmitter according to claim 6,
wherein the arrangement pattern is a pattern in which the outermost circle corresponds to the inscribed circle of the dynamic range upper limit.

9. An optical transmission device comprising:
optical transmitters, each including
a signal-processing circuit configured to perform signal processing on a first transmission signal and output a second transmission signal,
an optical modulator configured to modulate input light with the second transmission signal and to output an optical signal, and
a control circuit configured to output a control signal for controlling a carrier frequency of the optical signal to the signal-processing circuit; and
a multiplexer configured to multiplex optical signals output from the optical transmitters, the optical transmitters being configured to output the optical signals having carrier frequencies that are different from each other,
wherein the signal-processing circuit includes
a map-adjustment circuit configured to adjust a map position of the second transmission signal onto a complex plane, based on the control signal and a modulation format, and
a phase-rotation circuit configured to apply, on the complex plane, rotation of a phase of the carrier frequency corresponding to the control signal to the second transmission signal at the adjusted map position.

10. A transmission method comprising:
adjusting, by a signal-processing circuit, a map position of a transmission signal onto a complex plane when displacement of a carrier frequency of an output signal output from a transmitter is detected; and
applying, on the complex plane, rotation of a phase of the carrier frequency corresponding to an amount of the displacement of the carrier frequency to the transmission signal at the adjusted map position.
